(19) United States
(12) Patent Application Publication
(10) Pub. No.: US 2009/0028090 A1
(43) Pub. Date: Jan. 29, 2009

(54) METHOD AND SYSTEM OF WIRELESS COMMUNICATION BETWEEN DEVICES

(75) Inventors: Hong Cheng Sim, Singapore (SG); Hiroshi Doi, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD, Osaka (JP)

(21) Appl. No.: 11/995,317

(22) PCT Filed: Jun. 8, 2006
(86) PCT No.: PCT/SG06/00146

§ 371 Date: Jan. 10, 2008

(30) Foreign Application Priority Data
Jul. 14, 2005 (SG) 200504452-4

(51) Int. Cl. H04W 4/00

(52) U.S. Cl. 370/328

(57) ABSTRACT

A method and system for wireless communication between devices over the same channel in a Wireless Personal Area Networks (WPANs) environment, and a device capable of wireless communication with other devices over the same channel in a WPANs environment. The method comprises the steps of broadcasting announcements from one or more WPAN control devices; providing in each announcement an announcement portion for announcing information about one or more WPAN control devices other than said respective announcing WPAN control device; and partitioning medium access time for the communication between the devices over the same channel based on the announcements.

### FIELD OF INVENTION

The invention relates broadly to a method and system for wireless communication between devices over the same channel in a Wireless Personal Area Networks (WPANs) environment, and to a device capable of wireless communication with other devices over the same channel in a WPANs environment.

### BACKGROUND

For implementing Wireless Personal Area Networks (WPAN), there are provided Institute of Electrical and Electronic Engineers (IEEE) standards for wireless communication devices within a relatively limited operating space. Some widely used standards include the IEEE 802.15.3 standard and IEEE 802.15.4 standard.

In a IEEE 802.15.3 Medium Access Control (MAC) layer, medium access time is typically partitioned into periodic superframes. The network topology of the IEEE 802.15.3 MAC layer centralized controlled. Devices utilising the IEEE 802.15.3 MAC layer can typically be classified as being a normal operating device (DEV) or as being a Piconet Coordinator (PNC). A PNC typically broadcasts a beacon frame once every superframe. One or more DEVs, upon hearing the beacon frame, may typically choose to join the piconet of the PNC piconet and hence, forming a typical centralized controlled network centering about the PNC. Within each superframe of the IEEE 802.15.3 MAC layer, the medium access time is typically further divided into a beacon slot, a Contention Access Period (CAP) and a Channel Time Allocation Period (CTAP). The beacon slot is typically used by the PNC to broadcast a beacon without any contention. The CAP is typically used by the PNC and the one or more DEVs for transmitting command/response or contention-based traffic. The CTAP is typically divided into multiple slots reserved by the PNC for the one or more DEVs for contention-free communication.

In a IEEE 802.15.4 Low Rate WPAN standard, devices utilising the IEEE 802.15.4 MAC layer can typically be classified as being a Full Function Device (FFD) or as a Reduced Function Device (RFD). Depending on application requirements, the IEEE 802.15.4 standard may typically operate in either of two topologies. The two topologies are a star topology or a peer-to-peer topology. With regards to medium access, Time Division Multiple Access (TDMA) is typically used in the IEEE 802.15.4 MAC layer, similar to the IEEE 802.15.3 MAC layer. The devices, FFDs and RFDs, may typically share the medium access time using a Carrier Sense Multiple Access with Collision Avoidance (CSMA/CA) technique. As an option, a superframe structure may be used. The format of the superframe is typically defined by a coordinator or the FFD. The superframe is typically bounded by network beacons which are sent by the coordinator and the superframe is typically divided into 16 equally sized slots of an active region of the superframe. The superframe comprises an inactive period where there is no network activity. For applications requiring specific data bandwidth or low-latency applications, the coordinator may typically dedicate portions of the superframe to those applications. These dedicated portions are typically called Guaranteed Time Slots (GTSs). The GTSs form a contention-free period (CFP), which typically starts at the slot boundary immediately following the CAP and ends at the end of the superframe.

However, based on the above, when utilising typical WPAN IEEE standards, one problem for a WPAN is the relatively limited range of devices in the WPAN. A maximum WPAN device range is typically about 10 meters. Therefore, WPAN devices typically cannot communicate with devices 2 or more hops away. It may not be feasible for a user of a WPAN device to move closer to the destination device or, to increase transmission power due to limited power available on typical WPAN devices.

Another problem when utilising typical WPAN IEEE standards for a WPAN is link reliability. A typical WPAN may have a poor wireless link between a source device and a destination device that may cause the destination device to receive missing or corrupted data packets during communication. It has been recognised that environmental obstacles or conditions may affect reception at destination WPAN devices.

Hence, there exists a need for a method or system to address at least one of the problems above.

### SUMMARY

In accordance with a first aspect of the present invention, there is provided a method for communication between devices over the same channel in a Wireless Personal Area Networks (WPANs) environment, the method comprising the steps of: broadcasting announcements from one or more WPAN control devices; providing in each announcement an announcement portion for announcing information about one or more WPAN control devices of a WPAN other than the WPAN said respective announcing WPAN control device belongs to; and partitioning medium access time for the communication between the devices over the same channel based on the announcements.

One or more of the WPAN control devices may be retransmitting data from one device to another device based on the announcements.

The announcements may include route redundancy (RR) information and a RR contention free data (CFD) allocation by at least one WPAN control device, and the one or more WPAN control devices hearing said announcements may repeat data sent during said RR CFD allocation in a matching RR CFD allocation allocated by said hearing WPAN control devices based on the RR information.

The announcements may include route redundancy (RR) information and the WPAN control devices listen during contention access periods (CAPs) of one or more other WPAN control devices for RR contention based data (CBD) and the listening WPAN control devices may repeat said RR CBD in a CAP allocated by said listening WPAN control devices based on the RR information.

The medium access time may be partitioned into one or more control medium slots (CMSs) and one or more extension medium slots (EMSs), and the WPAN control devices may be restricted to transmit network control information within respective CMSs and EMSs.

Each CMS may comprise at least a beacon frame of one of the WPAN control devices.

Each CMS may further comprise a CAP of one of the WPAN control devices, and CBD transmissions may be performed within the CAP during the CMS.

CFD transmissions and/or CBD transmissions may be performed within the EMSs.

The medium access time may be further partitioned into one or more inactive medium slots (IMSs), and one or more of the IMSs may be selected to each function as a CMS or EMS in the event of collision between CMSs, EMSs, or both of different WPANs.

Each announcement may comprise the location of CMSs and EMSs used by WPAN control devices within radio range of the announcing WPAN control device.

A minimum superframe duration of the WPAN control devices may be identified, and the superframe duration of the WPAN control devices may be restricted to be equal to a integral multiple of the minimum superframe duration.

The medium slot boundaries used in different WPANs may be synchronised.

Each announcement may comprise a list of WPAN control devices within a radio range of the respective announcing WPAN control devices.

The WPAN devices, one or more WPAN slave devices, or both, may be listening to beacon frames of one or more of the WPAN control devices based on the list of WPAN control devices.

In accordance with a second aspect of the present invention, there is provided a system for wireless communication between devices over the same channel in a Wireless Personal Area Networks (WPANs) environment, the system comprising: one or more WPAN control devices broadcasting announcements, each announcement being provided with an announcement portion for announcing information about one or more WPAN control devices of a WPAN other than the WPAN said respective announcing WPAN control device belongs to; and wherein the WPAN control devices partition a medium access time for the communication between the devices over the same channel based on the announcements.

In accordance with a third aspect of the present invention, there is provided a device capable of wireless communication with other devices over the same channel in a Wireless Personal Area Networks (WPANs) environment, the device comprising a transceiver unit for broadcasting announcements when the device functions as a WPAN control device and for receiving broadcasting announcements from other WPAN control devices, wherein in each transmitted announcement the transceiver unit provides an announcement portion for announcing information about one or more WPAN control devices of a WPAN other than the WPAN said device functions as the control device for; and a wireless medium access control unit for partitioning medium access time for the communication with the other devices over the same channel based on the announcements.

The wireless medium access control unit may comprise a route redundancy control unit for retransmitting data to another device based on the announcements.

Said received announcements may include route redundancy (RR) information and a RR contention free data (CFD) allocation by at least one WPAN control device, and the route redundancy control unit may repeat data sent during said RR CFD allocation in a matching RR CFD allocation allocated by the route redundancy control unit based on the RR information.

Said announcements may include route redundancy (RR) information and the route redundancy control unit may listen during contention access period (CAPs) of one or more WPAN control devices for RR contention based data (CBD) and may repeat said RR CBD in a CAP allocated by the route redundancy control unit based on the RR information.

The wireless medium access control unit may comprise a medium slot management unit for partitioning the medium access time into one or more control medium slots (CMSs) and one or more extension medium slots (EMSs), wherein network control information transmissions are restricted to within respective CMSs and EMSs.

Each CMS may comprise at least a beacon frame of a WPAN control device.

Each CMS may further comprise a CAP of the WPAN control device, and the method further comprises performing CBD transmissions within the CAP during the CMS.

The device may perform CFD transmissions and/or CBD transmissions within the EMSs.

The medium slot management unit may further partition the medium access time into one or more inactive medium slots (IMSs), and may select one or more of the IMSs to each function as a CMS or EMS in the event of collision between CMSs, EMSs, or both of different WPANs.

Each announcement may comprise the location of CMSs and EMSs used by WPAN control devices within radio range of the announcing WPAN control device.

The or a medium slot management unit of the wireless medium access control unit may identify a minimum superframe duration of the WPAN control devices, and may restrict the superframe duration of the WPAN control devices to be equal to an integral multiple of the minimum superframe duration.

The or a medium slot management unit of the wireless medium access control unit may synchronise medium slot boundaries used in different WPANs.

Each announcement may comprise a list of WPAN control devices within a radio range of the respective announcing WPAN control devices.

The wireless medium access control unit may comprise a beacon RX/TX control unit for listening to beacon frames of one or more WPAN control devices based on the list of WPAN control devices.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1(a) is a schematic diagram illustrating a typical network topology of four separate networks.

FIG. 1(b) is a schematic diagram illustrating a network topology of a neighbourhood comprising four networks in an example embodiment.

FIG. 2 is a schematic diagram illustrating a number of Control Medium Slots (CMSs), Extension Medium Slots (EMSs) and Inactive Medium Slot (IMSs) as aligned to superframes of control devices in an example embodiment.

FIG. 3 is a schematic diagram illustrating medium access slots of two WPANs partitioned without synchronisation in an example embodiment.

FIG. 4 is a flowchart illustrating the process of sending a data packet using route redundancy in an example embodiment.

FIG. 5 is a flowchart illustrating the process of receiving contention-based data from a primary control device, and repeated contention-based data from a secondary control device.

FIG. 6 is a flowchart illustrating the process of repeating contention-based data by a control device in an example embodiment.

FIG. 7 is a flowchart illustrating the process of repeating contention-free data by a control device in an example embodiment.

FIG. 8 is a flowchart illustrating the process of receiving contention-free data by a control/slave device in an example embodiment.

FIG. 9 is a flowchart illustrating a method of wireless communication between devices over the same channel in a Wireless Personal Area Networks (WPANs) environment in an example embodiment.

FIG. 10 is a diagram showing a configuration of a wireless communication device.

FIG. 11 is a diagram showing the configuration within a wireless medium access control unit.

### DETAILED DESCRIPTION

The example embodiment described here can provide a method and a system for network extension and route redundancy in a WPAN environment. Route redundancy can be used for improving link reliability between WPAN devices.

In the example embodiment, to support Mesh Networking, a distributed medium access time sharing scheme is provided where devices from different WPANs can share the medium access time. In the example embodiment, the sharing and partitioning of the medium access time is carried out by utilising customised beacon frames that are broadcasted by control devices. Network control information comprising information of other control devices in a neighbourhood and data repeating requests are announced in the customised beacon frames in the example embodiment. Broadcasting of the customised beacon frames can allow WPAN devices to extend the network by establishing associations with other control devices based on the network control information. Route redundancy can also be achieved by using control devices to repeat data based on information/data sent by WPAN devices using the customised beacon frames.

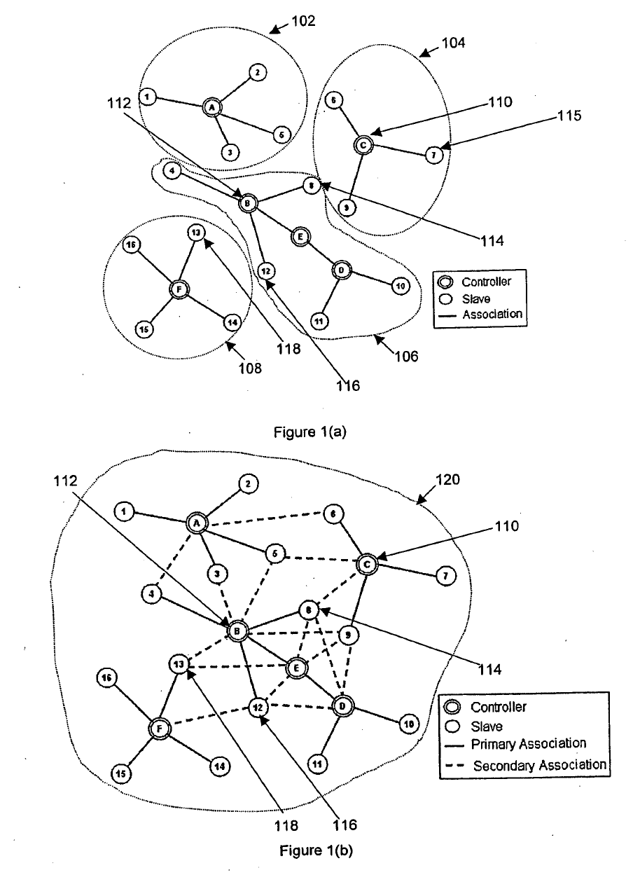

In the example embodiment, with reference to FIG. 1(a), separate WPANs e.g. 102, 104, 106 and 108 are provided. In the example embodiment, each WPAN e.g. 102 comprises at least one control device e.g. 110, 112 and at least one slave device e.g. 114, 116, 118. A slave device e.g. 114 is able to communicate with its associated control device e.g. 112. In the example embodiment, with reference to FIG. 1(b), the separate WPANs e.g. 102, 104, 106 and 108 are extended in network range by forming a neighbourhood 120 by sharing the medium access time. The neighbourhood 120 comprises the area where the devices e.g. 110 and 118 can e.g. communicate with one another. In the example embodiment, within the neighbourhood 120, a slave device e.g. 114 can associate with a secondary control device e.g. 110, in addition to being associated with a primary control device e.g. 112. Table 1 below summarises a list of the primary and secondary control devices e.g. 110, 112 associated with each of the slave devices e.g. 114, 116 in the neighbourhood 120.

TABLE 1
List of associations with primary and secondary control devices

| | Primary | Secondary |
|---|---|---|
| Slave | Controller | Controller(s) |
| 1 | A | — |
| 2 | A | — |
| 3 | A | B |
| 4 | B | A |
| 5 | A | B, C |
| 6 | C | A |
| 7 | C | — |
| 8 | B | C, D, E |
| 9 | C | B, D, E |
| 10 | D | — |
| 11 | D | — |
| 12 | B | D, E, F |
| 13 | F | B, E |
| 14 | F | — |
| 15 | F | — |
| 16 | F | — |

In the example embodiment, as illustrated in FIG. 1(b), network range extension is achieved for each of the original WPANs e.g. 108 by utilising Intermediate devices e.g. 112, 114 between a source device e.g. 118 and a destination device e.g. 110 to relay data. Furthermore, link reliability can be improved by route redundancy where more than one device e.g. 112, 116 in the neighbourhood 120 is utilised to repeat data from the source device e.g. 118 to the destination device e.g. 110 so that the data may reach the destination device e.g. 110 reliably. In the example embodiment, the control devices e.g. 110, 112 and the slave devices e.g. 114, 116, 118 in the neighbourhood 120 can share the medium access time, regardless of the original WPANs e.g. 102, 104, 106 and 108 each device e.g. 114 belongs to.

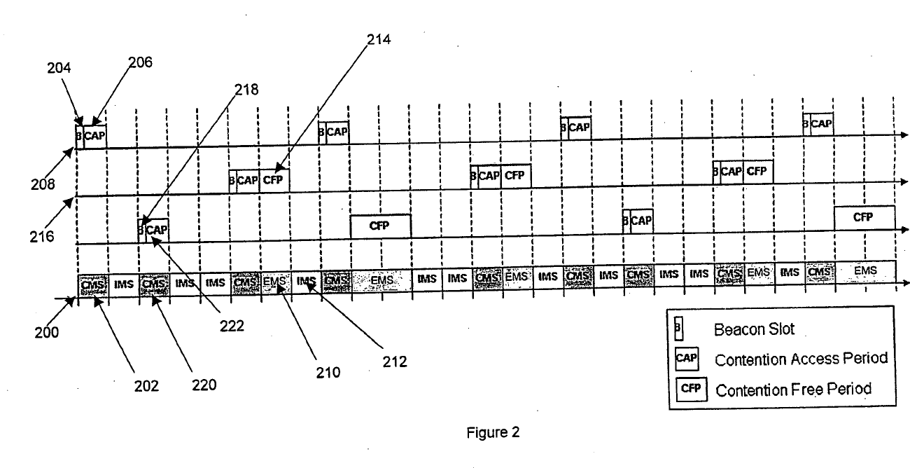

Turning now to FIG. 2, In the example embodiment, the medium access time 200 is partitioned. The medium access time 200 comprises control periods termed Control Medium Slots (CMSs) e.g. 202. The CMSs e.g. 202 are aligned with a beacon slot e.g. 204 and CAP e.g. 206 of the MAC layer 208 of a control device e.g. 110 (FIG. 1).

The medium access time 200 is further partitioned into Extension Medium Slots (EMSs) e.g. 210 and Inactive Medium Slots (IMSs) e.g. 212. The EMSs e.g. 210 can be reserved by a control device e.g. 112 (FIG. 1) for e.g. contention free communications, and are aligned with a CFP e.g. 214 of the MAC 216 of that control device. In the example embodiment, that control device can allocate Guaranteed Time Slots (GTSs) within the EMS 210 to be assigned to other devices that have requested for medium time reserved for contention-free data communication. The IMSs e.g. 212 are aligned with MAC layer periods not used for communication purposes.

In the example embodiment, the control device can also utilise the medium access period within the EMS e.g. 210 for control information transmission, data transmission or both. Thus, the EMSs e.g. 210 can be used by the control device for different purposes such as e.g. dividing the EMS 210 into a plurality of CFP slots, running a proprietary access protocol in the EMS 210, or if desired by the control device, using the EMS 210 for an “extended” CAP where contention-based data can be transmitted. In the example embodiment, the control device can allocated the EMSs e.g. 210 from the IMSs e.g. 212 when additional channel time is desired.

In the example embodiment, the alignment of the beacon slot e.g. 204 at the beginning of the CMS e.g. 202 facilitates that network control information can be announced by the control device e.g. 110 (FIG. 1) and received by the slave devices e.g. 114, 116, 118 (FIG. 1) before any contention-based data is broadcasted.

It is recognised that different control devices e.g. 110,112 (FIG. 1) may have different superframe durations. In the example embodiment, the different superframe durations are equal to or an integral multiple of a shortest superframe duration, SFDₘᵢₙ, used by the different control devices, and N is the number of partitions existing in that shortest superframe duration. The actual value of SFDₘᵢₙ is equal to the product of N and the duration of the CMSs e.g. 202. Conditions for the duration of the CMS e.g. 202 and N depend on the requirements in different embodiments. For example, if there is not a high requirement for control signalling and contention-based data exchange, the duration of the CMSs e.g. 202 can be relatively small. As another example, if 10 control devices are to be accommodated, N should be equal to or greater than 10.

In the example embodiment, the EMSs e.g. 210 and the IMSs e.g. 212 are of the same duration as the CMSs e.g. 202. The medium access time 200 is thus partitioned into equally sized blocks.

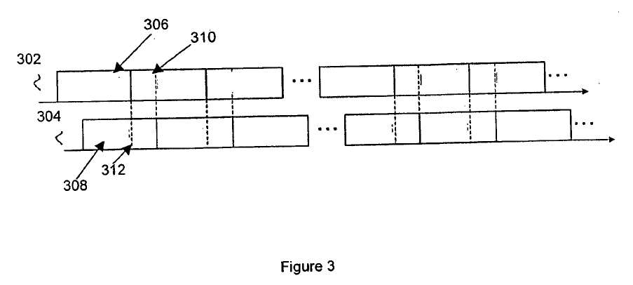

Next, a scenario where two WPANs, each using respective MAC layers 302, 304, move into range of each other will be described with reference to FIG. 3, in an example embodiment. The medium access time partitions e.g. 306, 308 in the respective MAC layers 302, 304 may not coincide. That is, the boundaries of the partitions e.g. 310, 312 may not be aligned. In the example embodiment, synchronisation of the partition boundaries e.g. 310, 312 is applied so that the two WPANs can share the same medium access time.

Synchronisation may e.g. be based on a synchronisation counter system in an example embodiment. Returning again to FIG. 1(a), each device e.g. 110, 115 keeps track of a synchronisation counter. The counter may e.g. be 16-bit, 24-bit, 32-bit or of any number of bits depending on implementation. The value of each synchronisation counter is set to a zero value when each device e.g. 110, 115 is powered up. For each control device e.g. 110, the synchronisation counter is incremented each time the control device 110 transmits its beacon frame. Thus, the synchronisation counter of each control device e.g. 110 is incremented once for every superframe of each control device e.g. 110. The synchronisation counter value of each control device e.g. 110 is included in the beacon frame announced so that other devices e.g. 112, 114, 116 can know that control device's counter value.

Slave devices e.g. 115 also increment their counter values once every superframe. Additionally, slave devices e.g. 115 adopt the counter value of a control device e.g. 110 the slave device 115 is contacting, if the counter value of that control device 110 is higher than the current counter value of the slave device. If the slave device e.g. 115 has a synchronisation counter value higher than the synchronisation counter value of that control device 110, a command packet indicating the higher counter value is sent from the device 115 to that control device 110, and that control device 110 will adopt the higher counter value received.

Control devices e.g. 110 hearing another control device's e.g. 112 beacon adopt the higher counter value between the two control devices 110, 112. In addition, the controle device e.g. 110 may send an explicit notification to inform the other control device e.g. 112 of its counter value. In the example embodiment, the control device e.g. 110, with the lower counter value initiates shifting the partition boundaries e.g. 310 (FIG. 3) so that the partition boundaries 310, 312 (FIG. 3) are aligned.

After synchronisation of the partition boundaries as e.g. described above, two or more devices e.g. 110, 112 may be utilising the same partition for either CMS-type or EMS-type purposes. This event is hereinafter termed as MS collision.

In the example embodiment, MS collision can be detected by two processes. One process is to listen to the beacon frames of the control devices e.g. 110, 112 of the joining groups of devices. As the CMSs and the EMSs are announced in the beacon frames, MS collision can be determined from the network control information in the beacon frames. Such a detection process may not detected certain MS collisions, e.g. CMS-CMS collision, or EMS-EMS collision between two slaves devices in the absence of their respective controller devices.

However, the second process in the example embodiment is to detect repetitive failure in data exchange or failure to receive beacon frames of the control devices e.g. 110, 112 of the joining groups of devices. Repetitive transmitting/receiving failures suggest the possibility of MS collision, and can detect CMS-CMS collision, or EMS-EMS collision between two slaves devices in the absence of their respective controller devices.

In the example embodiment, MS collisions are resolved by relocating the affected CMSs or EMSs to one or more IMSs of the shared medium access time.

To support network extension in the example embodiment, each control device e.g. 110 customises its beacon frame so that a list of other control devices e.g. 112 within radio range of the control device e.g. 110 is included in the beacon frame. In addition to the list of control devices, information relating to the CMSs e.g. 202 (FIG. 2) and the EMSs e.g. 208 (FIG. 2) of other control devices e.g. 112 within radio range is also announced in the beacon frame broadcast.

In the example embodiment, the slave devices e.g. 114, 116 can receive from the beacon frame of their primary control device e.g. 112 information relating to any other control devices e.g. 110 in the vicinity and the slave devices e.g. 114, 116 can then attempt to create secondary associations with the target secondary control devices e.g. 110. In the example embodiment, to create a secondary association, a slave device e.g. 114 listens to the CMS e.g. 202 (FIG. 2) of the target secondary control device e.g. 110. Secondary association between a slave device e.g. 116 and the target secondary control device 110 is not successful if that slave device 116 cannot receive beacon frames from the target secondary control device 110, e.g. the target control device is out of radio range of the slave device 116. An alternative way to create a secondary association is for the slave devices e.g. 114 to scan the communication medium to detect other control devices e.g. 110 within radio range.

In the example embodiment, to support the Mesh Networking in the neighbourhood 120, the slave devices e.g. 114, 116 first listen to the beacon slots e.g. 204 (FIG. 2) and any contention-based data in the associated CAPs e.g. 206 during the CMSs e.g. 202 (FIG. 2) of the primary control devices e.g. 112. In addition, the slave devices e.g. 114, 116 also listen to the beacon slots e.g. 218 (FIG. 2) during the CMS 220 (FIG. 2) of the target secondary control devices e.g. 110, if in radio range. In the example embodiment, after listening to the beacon slots 218 (FIG. 2) of the target secondary control devices e.g. 110, the slave devices e.g. 114, 116 may power down to save power without listening further to any contention-based data communication in the CAPs e.g. 222 (FIG. 2) of the target secondary control devices e.g. 110 during the CMS 220.

After describing how partitioning and sharing of medium access time can be utilised for network extension, the following description is provided for the customising of beacon frames to support route redundancy for transmitting both contention-based data and contention-free data in the example embodiment.

In relation to route redundancy in the example embodiment, with reference to FIG. 1(b), the beacon frames of the control devices e.g. 110, 112 are customised further to include information relating to data repeating. Data repeating and route redundancy can result in enhancing link reliability in the neighbourhood 120. For control devices e.g. 110 sending either contention-based or contention-free data to be repeated by repeater control devices e.g. 112 in the neighbourhood 120, the sending control devices e.g. 110 include a “Route Redundancy Request” (RRReq) field in the announcements of the broadcasted beacon frames.

In the example embodiment, the RRReq field can contain parameters relating to any routing algorithm or protocol. For example, the RRReq field can contain a “Time-to-Live” (TTL) value substantially similar to that used in the internet routing protocol. The TTL value is typically a counter value that is decremented every time the data is repeated. The RRReq field can also contain e.g. an address table substantially similar to that used in a typical DSR routing protocol. The address table, termed as a Routing Table, can be used to keep track of e.g. which of the repeater control devices e.g. 112 has repeated the data.

In the example embodiment, the TTL value prevents infinite repetition and stops the repeating of the data when the TTL value is decremented to zero. In the example embodiment, the Routing Table is used to contain a list of device identification information for repeater control devices e.g. 112 that have repeated the data packet. The RRReq field initially contains an empty Routing Table when requesting for repeater control devices e.g. 112 to repeat the data packet. The Routing Table is updated each time the data packet is repeated by a repeater control device e.g. 112 as each repeater control device e.g. 112 adds its own device identification information to the Routing Table. The Routing Table may be used to control repeating of the data packet such that the data packet does not get repeated for more than a preset number of times by a repeater control device e.g. 112.

In the example embodiment, a destination device can discard repeated data packets if the “original” data is received without errors. Receipt of repeated data packets is useful when the destination device receives “original” data with errors.

For repeating contention-based data, in the example embodiment, control devices e.g. 112 in the neighbourhood 120 may be activated to repeat the contention-based data. When contention-based data is to be repeated, the repeater control devices e.g. 112 are termed as “Contention-Based Data Repeaters” (CBD Repeaters).

Each CBD Repeater e.g. 112 listens during the CMSs e.g. 202 (FIG. 2) of neighbour control devices e.g. 110 for contention-based data in the CAP e.g. 206 (FIG. 2) after the beacon slot e.g. 204 (FIG. 2). When a CBD Repeater e.g. 112 receives a contention-based data packet with a “RRReq” field in the header of the contention-based data packet, the CBD Repeater e.g. 112 decides if the contention-based data packet is to be repeated based on the routing parameters in the RRReq field. In the example embodiment, the routing parameters are the TTL value and the Routing Table. If the TTL value has reached a value of zero, the contention-based data packet is not repeated. Similarly, if the Routing Table contains device identification information of the CBD Repeater e.g. 112 and that the contention-based data packet is not to be repeated by the corresponding device identification information, the contention-based data packet is not repeated by the CBD Repeater e.g. 112.

In the example embodiment, when the contention-based data is to be repeated, the CBD Repeater e.g. 112 customises its beacon frame in the beacon slot e.g. 204 (FIG. 2) to contain a notification field to announce that there is a contention-based data packet to be repeated in the following CAP e.g. 206 (FIG. 2) during the CMS e.g. 202 (FIG. 2). The contention-based data packet to be repeated is then transmitted by the CBD Repeater e.g. 112 to devices alerted by the customised beacon frame.

In the example embodiment, a destination device e.g. 114, upon hearing the notification of repeated contention-based data in the announcement addressed to itself, then listens to the CAP e.g. 206 (FIG. 2) of the CBD Repeater e.g. 112 for the contention-based data packet.

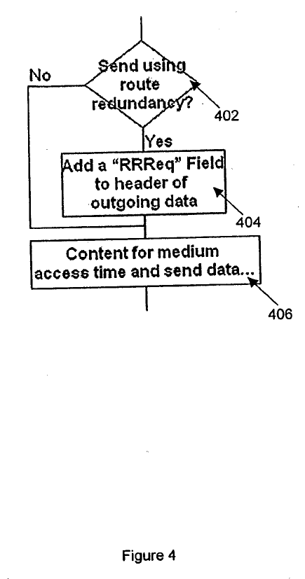

FIG. 4 is a flowchart illustrating the process of sending data using route redundancy by a control/slave source device e.g. 112, 114 (FIG. 1). At step 402, a check is made by the control/slave source device e.g. 112, 114 (FIG. 1) to determine if the data is to be sent by route redundancy. If the data is to be sent by route redundancy at step 402, at step 404, a RRReq field is added to the header of the outgoing data by the control/slave source device e.g. 112, 114 (FIG. 1). At step 406, the control/slave source device e.g. 112, 114 (FIG. 1) waits for the medium slot for data communication and transmits the outgoing data. If no data is to be sent by route redundancy at step 402, the control/slave source device e.g. 112, 114 (FIG. 1) waits for the medium slot for data communication and transmits outgoing data without the RRReq field. In the example embodiment, route redundancy can be requested by any device by adding the RRReq field in the header of the outgoing contention-based data packet.

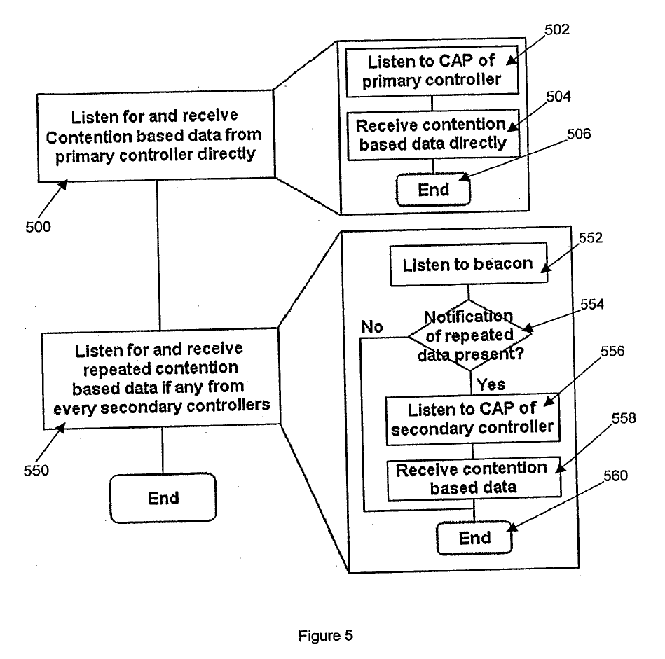

FIG. 5 is a flowchart illustrating the process of receiving contention-based data from a primary control device at numeral 500, and repeated contention-based data from a secondary control device at numeral 550. In more detail, at step 502, the receiving device listens to the CAP of its primary control device, and at step 504 receives contention based data directly. At step 506, the receipt ends.

On the other hand, at step 552, the receiving device listens for a beacon frame from its secondary control device. If the beacon frame includes a notification of repeated data present at step 554, the receiving device listens to the CAP of the secondary control device at step 556 and receives the repeated contention based data at step 558, before the process ends at numeral 560. If no notification of repeated data is present at step 554, the receiving device does not listen to the CAP, and the process ends at numeral 560.

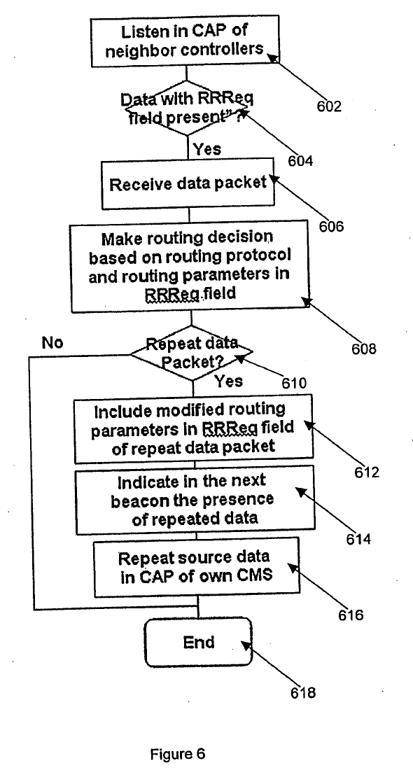

FIG. 6 is a flowchart illustrating the process of repeating contention-based data by a control device. At step 602, the control device listens to the CAP of neighbourhood control devices. At step 604, the control device determines if there is any contention-based data with a RRReq field present in the CAP of neighbourhood control devices. If there is contention-based data with a RRReq field present in the CAP at step 604, at step 606, the contention-based data packet is received by the control device. At step 608, the control device makes a routing decision based on routing information and protocol in the RRReq field. At step 610, a check is made to determine if the contention-based data packet should be repeated based on repeating information in the RRReq field. If the contention-based data packet is to be repeated at step 610, at step 612, the routing parameters in the RRReq field of the repeat data packet are modified and updated by the control device e.g. 112 (FIG. 1) and, at step 614, the next beacon frame of the control device e.g. 112 (FIG. 1) includes information relating to the presence of the contention-based data packet to be repeated. At step 616, the contention-based data packet is repeated in the CAP of the CMS of the current control device. At step 618, the control device ends sending of data. If the contention-based data packet is not to be repeated at step 610, the control device ends sending of data at step 618.

For repeating contention-free data, in the example embodiment and with reference to FIG. 1, control devices e.g. 112 in the neighbourhood 120 may also be activated to repeat contention-free data. To repeat contention-free data, a sending control device e.g. 110 allocates GTSs for transmitting contention-free data by using a GTS request command coupled with an additional RRReq field. In the example embodiment, a GTS allocation request command coupled with a specified RRReq field results in a “Route Redundancy GTS” (RRGTS), instead of a normal GTS, being allocated in the medium access time e.g. 300 (FIG. 3) for the sending control device e.g. 110. For repeating purposes, the RRGTS is announced by each repeater control device e.g. 112 in its beacon frame together with the RRReq field. In the example embodiment, when contention-free data is to be repeated, the repeater control devices e.g. 112 activated to repeat contention free data in RRGTS are termed as “Contention-Free Data Repeaters” (CFD Repeaters).

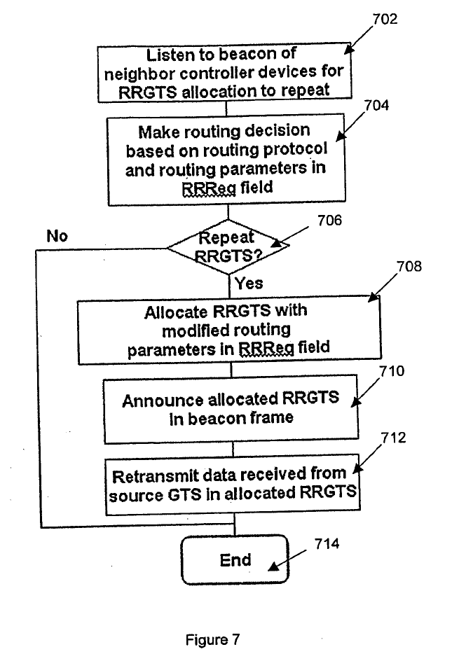

FIG. 7 is a flowchart illustrating the process of repeating contention-free data by a control device. At step 702, the control device listens to the beacon frames of neighbourhood control devices to determine if there is any RRGTS allocation to repeat contention-free data. At step 704, if there is a RRGTS allocation to repeat the contention-free data present in the beacon frame of neighbourhood control devices at step 702, the control device makes a routing decision based on routing information and protocol in the RRReq field. At step 706, a check is made to determine if the RRGTS should be repeated based on information in the RRReq field. If the RRGTS is to be repeated at step 706, at step 708, the control device modifies the routing parameters in the RRReq field and allocates a RRGTS in its EMS coupled with the modified RRReq field. At step 710, the control device announces the RRGTS in its beacon frame. At step 712, the control device retransmits data received from the source GTS in its allocated RRGTS. At step 714, the control device ends sending of data. If the RRGTS is not to be repeated at step 706, the control device ends sending of data at step 714.

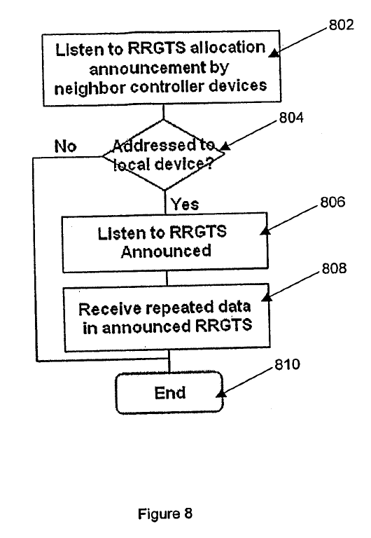

FIG. 8 is a flowchart illustrating the process of receiving contention-free data by a control/slave destination device. At step 802, the control/slave destination device listens for any RRGTS allocation announcements by neighbouring control devices. If there is RRGTS allocation by neighbouring control devices e.g. 110 (FIG. 1) at step 802, at step 804, a check is made to determine if the RRGTS allocation is directed at the current control/slave destination device. If the control/slave destination device is the destination device at step 804, at step 806, the control/slave destination device listens to the RRGTS announcement. At step 808, the control/slave destination device receives the repeated contention-free data in the RRGTS. At step 810, the control/slave destination device returns to listening for any RRGTS allocation announcements by the neighbouring control devices. If the RRGTS allocation is not directed at the current control/slave destination device at step 804, the control/slave device ends listening to the particular RRGTS allocation announcement at step 810.

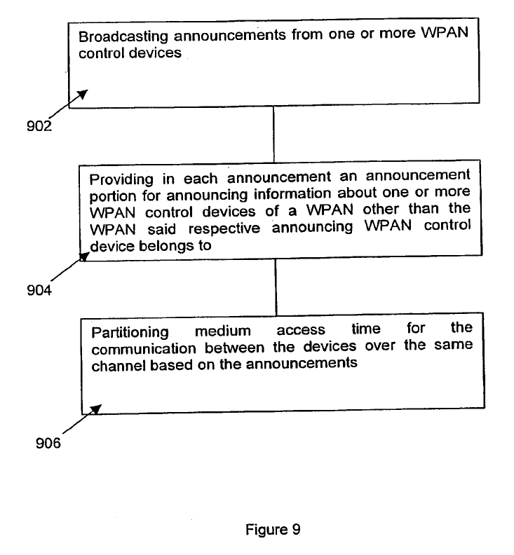

FIG. 9 is a flowchart illustrating a method of wireless communication between devices over the same channel in a Wireless Personal Area Networks (WPANs) environment in an example embodiment. At step 902, announcements from one or more WPAN control devices are broadcasted, at step 904, each announcement is provided with an announcement portion for announcing information about one or more WPAN control devices of a WPAN other than the WPAN said respective announcing WPAN control device belongs to; and at step 906, medium access time for the communication between the devices over the same channel is partitioned based on the announcements.

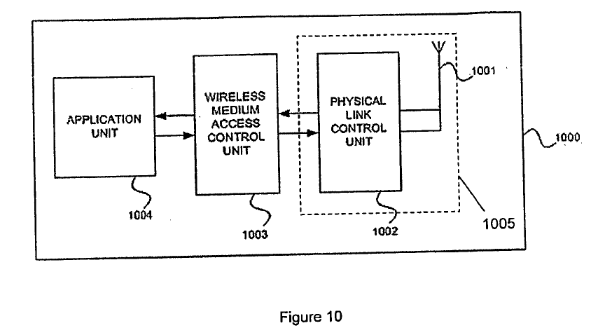

FIG. 10 is a block diagram of a wireless communication device 1000 for implementation of the method and system of wireless communication between devices described above. In FIG. 10, the wireless communication device 1000 comprises of transceiver unit 1005, a wireless medium access control unit 1003 and application unit 1004. The transceiver unit 1005 includes a wireless antenna 1001, and a physical link control unit 1002. The wireless antenna 1001 transmits analog signals into the wireless medium and receives analog signals from the wireless medium. The physical link control unit 1002 converts received analog signals from wireless antenna 1001 into digital signals with signal processing procedures such as modulation and coding and generates digital frames. In addition, the physical link control unit 1002 also converts digital signal frames into analog signals with signal processing procedures such as demodulation and decoding and transmits the analog signals via the wireless antenna 1001. The wireless medium access control unit 1003 receives and transmits digital frames from and to the physical link control unit 1002. In addition, the medium access control unit ensures that multiple communication devices are capable of operating in the same operating channel. The application unit 1004 contains user-level programs such as file transfer program and multi-media content streaming applications that make use of the wireless communication.

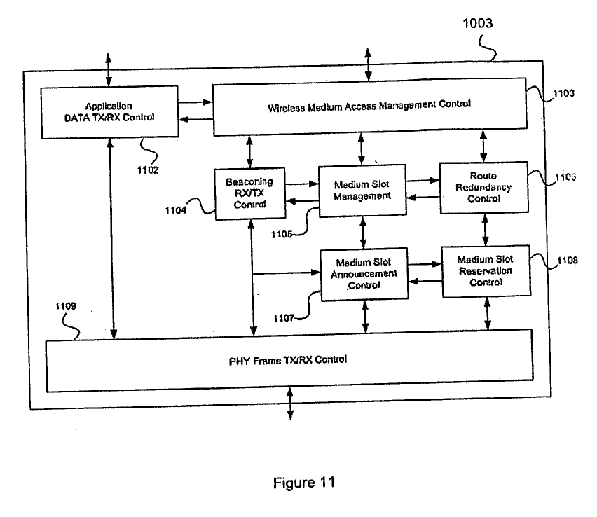

FIG. 11 is a block diagram of the wireless medium access control unit 1003. The wireless medium access control unit 1003 comprises of Application Data TX/RX control unit 1102, Wireless Medium Access Management control unit 1103, Beaconing RX/TX control unit 1104, Medium slot management unit 1105, Route Redundancy Control unit 1106, Medium Slot Announcement control unit 1107, Medium slot Reservation control unit 1108 and Physical Layer (PHY) frame TX/RX control unit 1109. The Application Data TX/RX control unit 1102 receives data packets from application unit 1004 (FIG. 10) and adds additional control information and/or performs fragmentation if necessary. In addition, the Application Data TX/RX control unit 1102 receives data frames meant for application unit 1004 and merges fragmented data (if any) and sends the data to application unit 1004. The Wireless Medium Access Management control unit 1103 contains the main logic and algorithm to manage medium access sharing between multiple wireless communication devices. The Beaconing RX/TX control unit 1104 contains the logic and algorithms to decode and encode beacon frames and performs scheduling functions for beacon frame reception or transmission. The Medium slot management unit 1105 contains the logic and algorithms to monitor medium slots' occupancy status. The Route Redundancy Control unit 1106 manages how the communication device 1000 (FIG. 10) performs route redundancy to improve data reliability. The Medium Slot Announcement control unit 1107 determines the announcement information that is to be broadcasted to notify neighbour devices about the current medium slot occupancy situation. In addition, the Medium Slot Announcement control unit 1107 also decodes received announcement information and determines any changes that need to be updated in the medium slot management unit 1105. The Medium slot Reservation control unit 1108 contains the logic and algorithm to perform outgoing medium slot reservation as well as handling incoming medium slot reservation requests or reservation notifications. The PHY frame TX/RX control unit 1109 receives frames from physical link control unit 1002 (FIG. 10) and decodes whether a packet is an application data packet and/or contains any other control information to be processed by Wireless Medium Access control unit 1003.

The method, system and device described herein can enable a WPAN device to be able to communicate with any device in a neighbourhood. In addition, WPAN devices can determine the existence of other WPAN devices that are 2 hops away, hence providing support for network extension. The example embodiment can also enable WPAN devices to be able to enhance link reliability during data exchange for both contention-based data and contention-free data by utilising route redundancy.

The method and system in the example embodiment above can be applied to any WPAN system including the IEEE 802.15.3 and IEEE 802.15.4 MAC standards. For example, in the IEEE 802.15.3 context, a DEV may be able to transmit to multiple PNCs and in the IEEE 802.15.4 context, a RFD may be able to transmit to multiple FFDs. Both of these are not supported by the current standards. It has been recognised that current IEEE standards typically do not support the above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of wireless communication between devices over the same channel in a Wireless Personal Area Networks (WPANs) environment, the method comprising the steps of:
broadcasting announcements from one or more WPAN control devices;
providing in each announcement an announcement portion for announcing information about one or more WPAN control devices of a WPAN other than the WPAN said respective announcing WPAN control device belongs to; and
partitioning medium access time for the communication between the devices over the same channel based on the announcements.

2. The method as claimed in claim 1, further comprising one or more of the WPAN control devices retransmitting data from one device to another device based on the announcements.

3. The method as claimed 2, wherein said announcements include route redundancy (RR) information and a RR contention free data (CFD) allocation by at least one WPAN control device, and the one or more WPAN control devices hearing said announcements repeat data sent during said RR CFD allocation in a matching RR CFD allocation allocated by said hearing WPAN control devices based on the RR information.

4. The method as claimed in claim 2, wherein said announcements include route redundancy (RR) information and the WPAN control devices listen during contention access periods (CAPs) of one or more other WPAN control devices for RR contention based data (CBD) and the listening WPAN control devices repeat said RR CBD in a CAP allocated by said listening WPAN control devices based on the RR information.

5. The method as claimed claim 1, wherein the medium access time is partitioned into one or more control medium slots (CMSs) and one or more extension medium slots (EMSs), and the method further comprises restricting the WPAN control devices to transmit network control information within respective CMSs and EMSs.

6. The method as claimed in claim 5, wherein each CMS comprises at least a beacon frame of one of the WPAN control devices.

7. The method as claimed in claim 6, wherein each CMS further comprises a CAP of one of the WPAN control devices, and the method further comprises performing CBD transmissions within the CAP during the CMS.

8. The method as claimed in claim 1, further comprising performing CFD transmissions and/or CBD transmissions within the EMSs.

9. The method as claimed in claim 1, wherein the medium access time is further partitioned into one or more inactive medium slots (IMSs), and the method further comprises selecting one or more of the IMSs to each function as a CMS or EMS in the event of collision between CMSs, EMSs, or both of different WPANs.

10. The method as claimed in claim 1, wherein each announcement comprises the location of CMSs and EMSs used by WPAN control devices within radio range of the announcing WPAN control device.

11. The method as claimed in claim 1, further comprising identifying a minimum superframe duration of the WPAN control devices, and restricting the superframe duration of the WPAN control devices to be equal to a integral multiple of the minimum superframe duration.

12. The method as claimed in claim 1, further comprising synchronising medium slot boundaries used in different WPANs.

13. The method as claimed in claim 1, wherein each announcement comprises a list of WPAN control devices within a radio range of the respective announcing WPAN control devices.

14. The method as claimed in claim 13, further comprising the WPAN devices, one or more WPAN slave devices, or both, listening to beacon frames of one or more of the WPAN control devices based on the list of WPAN control devices.

15. A system for wireless communication between devices over the same channel in a Wireless Personal Area Networks (WPANs) environment, the system comprising:
one or more WPAN control devices broadcasting announcements, each announcement being provided with an announcement portion for announcing information about one or more WPAN control devices of a WPAN other than the WPAN said respective announcing WPAN control device belongs to; and wherein the WPAN control devices partition a medium access time for the communication between the devices over the same channel based on the announcements.

16. A device capable of wireless communication with other devices over the same channel in a Wireless Personal Area Networks (WPANs) environment, the device comprising:
a transceiver unit for broadcasting announcements when the device functions as a WPAN control device and for receiving broadcasting announcements from other WPAN control devices, wherein in each transmitted announcement the transceiver unit provides an announcement portion for announcing information about one or more WPAN control devices of a WPAN other than the WPAN said device functions as the control device for; and
a wireless medium access control unit for partitioning medium access time for the communication with the other devices over the same channel based on the announcements.

17. The device as claimed in claim 16, wherein the wireless medium access control unit comprises a route redundancy control unit for retransmitting data to another device based on the announcements.

18. The device as claimed 17, wherein said received announcements include route redundancy (RR) information and a RR contention free data (CFD) allocation by at least one WPAN control device, and the route redundancy control unit repeats data sent during said RR CFD allocation in a matching RR CFD allocation allocated by the route redundancy control unit based on the RR information.

19. The device as claimed in claim 17, wherein said announcements include route redundancy (RR) information and the route redundancy control unit listens during contention access period (CAPs) of one or more WPAN control devices for RR contention based data (CBD) and repeats said RR CBD in a CAP allocated by the route redundancy control unit based on the RR information.

20. The device as claimed in claim 16, wherein the wireless medium access control unit comprises a medium slot management unit for partitioning the medium access time into one or more control medium slots (CMSs) and one or more extension medium slots (EMSs), wherein network control information transmissions are restricted to within respective CMSs and EMSs.

21. The device as claimed in claim 20, wherein each CMS comprises at least a beacon frame of a WPAN control device.

22. The device as claimed in claim 21, wherein each CMS further comprises a CAP of the WPAN control device, and the method further comprises performing CBD transmissions within the CAP during the CMS.

23. The device as claimed in claim 20, wherein the device performs CFD transmissions and/or CBD transmissions within the EMSs.

24. The device as claimed in claim 20, wherein the medium slot management unit further partitions the medium access time into one or more inactive medium slots (IMSs), and selects one or more of the IMSs to each function as a CMS or EMS in the event of collision between CMSs, EMSs, or both of different WPANs.

25. The device as claimed in claim 20, wherein each announcement comprises the location of CMSs and EMSs used by WPAN control devices within radio range of the announcing WPAN control device.

26. The device as claimed in claim 20, wherein the or a medium slot management unit of the wireless medium access control unit identifies a minimum superframe duration of the WPAN control devices, and restricts the superframe duration of the WPAN control devices to be equal to an integral multiple of the minimum superframe duration.

27. The device as claimed in claim 20, wherein the or a medium slot management unit of the wireless medium access control unit synchronises medium slot boundaries used in different WPANs.

28. The device as claimed in claim 20, wherein each announcement comprises a list of WPAN control devices within a radio range of the respective announcing WPAN control devices.

29. The device as claimed in claim 28, wherein the wireless medium access control unit comprises a beacon RX/TX control unit for listening to beacon frames of one or more WPAN control devices based on the list of WPAN control devices.
